(19) United States
(12) Patent Application Publication
(10) Pub. No.: US 2011/0149388 A1
(43) Pub. Date: Jun. 23, 2011

(54) OPERATING CIRCUIT AND CONTROL METHOD FOR A PHOTOMULTIPLIER

(75) Inventors: Mirko LIEDTKE, Jena (DE); Johannes WEBER, Jena (DE)

(73) Assignee: CARL ZEISS MICROIMAGING GMBH, Jena (DE)

(21) Appl. No.: 12/970,007

(22) Filed: Dec. 16, 2010

(30) Foreign Application Priority Data
Dec. 18, 2009 (DE) 10 2009 060 309.3

(51) Int. Cl. G02B 21/06; H01J 40/14

(52) U.S. Cl. 359/385; 250/207

(57) ABSTRACT

A operating circuit and control method for protecting a PMT having a photocathode, a plurality of dynodes and an anode against overloading with a shorter reaction time, and to allow it to be switched on again rapidly. For this purpose, a switch is provided for electrically short circuiting the photocathode with the first dynode, or a switch is provided for reversing the polarity of the voltage between the photocathode and the first dynode.

### CROSS-REFERENCE TO RELATED APPLICATION(S)

The present patent application is based on and claims priority from German Application No. 10 2009 060 309.3, filed Dec. 18, 2009, which is incorporated herein by reference in its entirety.

### BACKGROUND OF THE INVENTION

(1) Field of the Invention

The invention relates to an operating circuit for a photomultiplier (PMT), which presents a photocathode, several dynodes and an anode, with an electrical circuit to stress the dynodes with a respective voltage with reference to the photocathode, as well as to a control method for such a photomultiplier, where the dynodes are stressed with a respective voltage with reference to the photocathode.

(2) Description of Related Art Including Information Disclosed Under 37 CFR 1.97 and 1.98

The voltage, that is the electrical potential with respect to the photocathode, depends on the distance between the dynode in question and the photocathode. Typically, the dynodes are connected to a voltage divider chain, to which a high voltage is applied, so that the dynodes represent a potential cascade. As a result, photomultipliers are sensitive optoelectronic converters. Depending on the photon current density to be expected, the electronic amplification which is connected downstream can be regulated. It is also possible to influence the amplification by modifying the high voltage; however, this type of setting is slow.

In the case of a strong light incidence on the photocathode, high electron beam densities occur within the evacuated multiplier tube. As a result, the probability of an impact ionization of residual gas molecules in the vacuum increases, which impact ionization in turn could damage the photocathode. This condition is referred to as “ion feedback.” The anode can also be damaged in case of high photon current densities. Control means for photomultipliers are therefore are usually equipped with safety cut offs for the high voltage. The cut offs react to an excessively high current density.

Photomultipliers are used, for example, in confocal laser scanning microscopes (LSM), where a sample is scanned, to record an image pixel by pixel. The light intensity recorded by the PMT during the so-called pixel dwell time is assigned to each pixel. The user must balance competing goals, to obtain an optimal image of an object under investigation. The user must be able to introduce dyes in an appropriate way into the sample, without changing or destroying it, and illuminate it sufficiently to use the detector to maximum level. Often, in case of weakly fluorescing samples, the useful signal disappears in the noise of the detector, so that only a low contrast can be achieved.

Samples that are particularly problematic are those that fluoresce considerably more strongly in small areas—so-called “beads”—than in the rest of the sample. For example, if neurons and their branches are stained with fluorophores, then the neuron will transmit a large quantity of light, and the synapses, in contrast, only little light. To be able to represent synapses well, the amplification of the detector has to be set very high. In the areas of the image where a neuron is represented, this invariably leads to overdriving of the PMT, and consequently, in the simplest case, to artifacts.

In the case of strong overdriving, the overload protection even switches the operational high voltage of the PMT completely off. This safety cut off can occur, for example, according to JP 2004 069752 A2 by means of a comparator as a function of the anode signal. The reaction time of the high voltage is here in the range of milliseconds, which is very slow in comparison to the pixel dwell time which is typically a few microseconds. As a result, during the scanning of a very bright area, there is a delay in switching off the PMT, which can damage the latter, and an even longer delay in switching the PMT on again, so that the subsequent sample areas are not recorded at all.

FIG. 1 is intended to clarify these consequences. For a better understanding, the space-time conditions are represented in a simplified way. A sample with a neuron N with synapses S is scanned, and meanwhile the local fluorescence intensities are recorded by means of a PMT with switched on high voltage as corresponding pixels P (black sections of the solid line indicated). During the scanning of the neuron N, the synapses S that lie in the scanning direction of the body of the neuron N are recorded correctly. As soon as the focus is in the body of the neuron N, the intensity is sufficiently high so that the PMT is overloaded (white section of the solid line). The safety cut off of its operational high voltage, however, takes some time (due to the simplified illustration, here only approximately three pixels P), during which the overloading continues. It is only at the time A that the high voltage has collapsed. The scanning process is then continued with switched off high voltage (white section of the broken line). When the focus leaves the body of the neuron N, the decreasing intensity is detected, and the high voltage is switched on again. Because of switching slowness, it takes some time (due to the simplification, here only approximately five pixels P), until time B when the high voltage is established, and the PMT again yields correct data. As a result, the synapses S which lie in the scanning direction behind the body of the neuron N are not detected.

It is indeed possible to shut down the safety cut off of the high voltage, in order to be able to also record lower intensity areas that occur subsequently to sample areas with high intensity. However, under the high load, the detector is stressed more, which results in a loss of its sensitivity, and shortens its useful life.

Alternatively to the safety cut off of the high voltage, one can, for example, according to WO 2004/102249 A1 adjust the illumination using “controlled/correlative light exposure microscopy,” CLEM. However, this does not result in reaction times on the order of microseconds. In JP 2006 126375 A2, a regulation is described which continuously adjusts the variable amplification of the PMT, to be able to use the analog-digital conversion and possibly the PMT to optimum level. In the process, the PMT operational high voltage normally remains constant. A combination of this procedure is described in JP 2001 021808 A2. Here, an image is first recorded, in order to be able to derive a regulatory parameter from its brightness distribution, which influences the illumination and/or PMT amplification.

In all the methods known to date, the reaction time is clearly longer than the pixel dwell time, so that, in the LSM, the PMT especially the illumination cannot be switched off with pixel precision. For other applications of PMT, a more rapidly reacting protection against overload would also be advantageous, for the purpose of maximizing the useful life.

### BRIEF DESCRIPTION OF THE INVENTION

The present invention is based on the problem of improving an operating switch of the type described at the beginning, and to provide a corresponding control method so that a PMT can be protected against overload, with shorter reaction time.

The problem is solved by an operating circuit for a photomultiplier which has a photocathode, several dynodes and an anode, with an electrical circuit to apply to the dynodes a respective voltage with respect to the photocathode, characterized by a switch for electrically short circuiting the photocathode with the dynode that is closest to the photocathode. The problem is also solved by a control method for a photomultiplier which has a photocathode, several dynodes and an anode, where the dynodes are stressed by a respective voltage with respect to the photocathode, characterized in that the photocathode is electrically short circuited with the dynode that is closest to the photocathode.

According to the invention, the photocathode is connected by an electrical short circuit to the dynode that is closest to the photocathode. For this purpose, for the operating circuit, a switch is provided for electrically short circuiting the photocathode with the dynode that is closest to the photocathode. The dynode that is closest to the photocathode is also referred to as the first dynode. It presents the lowest potential difference with respect to the photocathode.

The function of the first acceleration level of the dynode cascade is decisive for the overall amplification. By short circuiting the first dynode with the photocathode, the first acceleration level can be deactivated with extremely short reaction times of less than one microsecond. If, in the first acceleration level, no electrons are accelerated, then only a few of them reach the next levels, so that the anode signal becomes substantially weaker, and as a result the PMT is protected particularly against the residual gas ionization. It is particularly advantageous that, by interrupting the short circuit, the first acceleration level and thus the data recording can be reactivated also with extremely short reaction times of less than one microsecond. Depending on the PMT type, between two dynodes, only 1/9 to 1/11 of the operational high voltage is applied, that is less than 150 V, which can be cut off with little effort by a switch.

The short circuiting occurs advantageously if it has been identified that a value of an anode signal exceeds a predetermined first threshold value. For this purpose, the operating circuit can present a first comparator for comparing an anode signal with a predetermined first threshold value, where the comparator is connected to the switch, and closes the switch if a value of the anode signal exceeds the first threshold value. The identification of an overload is possible, with little effort, using the anode signal by means of a comparator.

Preferred embodiments are those in which the first threshold value is below a triggering threshold value of a safety cut off for a high voltage of the photomultiplier. As a result, the protection according to the invention becomes active in case of an overloading of the PMT before the slow safety cut off of the high voltage does. If the short circuit is not established successfully for any reason, the safety cut off of the high voltage is available additionally.

It is also preferred to interrupt the short circuit, if it has been identified that a value of the anode signal falls below a predetermined second threshold value. For this purpose, the operating circuit can present a second comparator for comparing the anode signal with a predetermined second threshold value, where the comparator is connected to the switch, and opens the switch if a value of the anode signal falls below the second threshold value. The identification of an end of the overloading is possible, with little effort, using the anode signal by means of a comparator.

Advantageously, the remaining dynodes, in the case of a short circuit of the first dynode with the photocathode, can present, with respect to the photocathode, an electrical potential that is different than zero—in other words, the high voltage is maintained. As a result, even if the first acceleration level is deactivated, an incident light intensity proportional to the anode signal is available. Using it, an end of a very bright sample area can be identified with short reaction time.

In special embodiments, the two comparators are identical and/or the two threshold values are identical. As a result, the rapid deactivation and reactivation of the first acceleration level is achieved at low cost. Identical comparators can be produced, for example, in the form of a threshold value switch (“Schmitt trigger”) which produces, with different threshold values, a switch hysteresis.

The switch is advantageously insulated from the high voltage of the photomultiplier.

The invention also comprises an operating circuit of the type mentioned in the introduction, which, as protection against a high light intensity, provides an electrical switch for reversing the polarity of the voltage between the dynode that is closest to the photocathode, and the photocathode and a control unit which activates the polarity reversal, if it identifies that a value of an anode signal exceeds a predetermined first threshold value, and deactivates the polarity reversal after a predetermined time period. The polarity reversal of the voltage between the first dynode and the photocathode, for example, from −150 V of the cathode in reference to the first dynode to +150 V, acts as an electron decelerator. As a result, approximately no electrons reach the anodes any longer, and the anode signal vanishes. This too represents an active deactivation of the first acceleration step. According to the invention, the value of the voltage during the “polarity reversal” does not have to remain constant, rather it can be changed, for example, it can be decreased or increased with respect to the acceleration polarity. However, polarity reversal is considerably more costly than short circuiting.

The invention comprises particularly an LSM with an operating circuit as described above. In connection with an LSM, which in itself is known. The invention has the advantage that the image recording can be continued with full sensitivity immediately after the end of a very bright sample area.

The switch for short circuiting advantageously presents a maximum reaction time of 1 μs. As a result, an LSM is capable of using pixel by pixel deactivation and reactivation of the PMT even with short pixel dwell times.

### BRIEF DESCRIPTION OF THE SEVERAL VIEWS OF THE DRAWINGS

The invention is explained in greater detail below in reference to several embodiments and the drawings as follows:

FIG. 1 schematically shows the scanning of a sample with great differences in the local fluorescence intensity according to the state of the art,

FIG. 2 is a simplified schematic circuit diagram of a PMT operating circuit,

FIG. 3 is a schematic of a laser scanning microscope,

FIG. 4 schematically shows the scanning of a sample with great differences in the local fluorescence intensity according to the invention, and

FIG. 5 is a simplified schematic circuit diagram of a PMT operating circuit for reversing voltage polarity.

### DETAILED DESCRIPTION OF THE INVENTION

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose. Equivalent parts in all the drawings bear the same reference numerals.

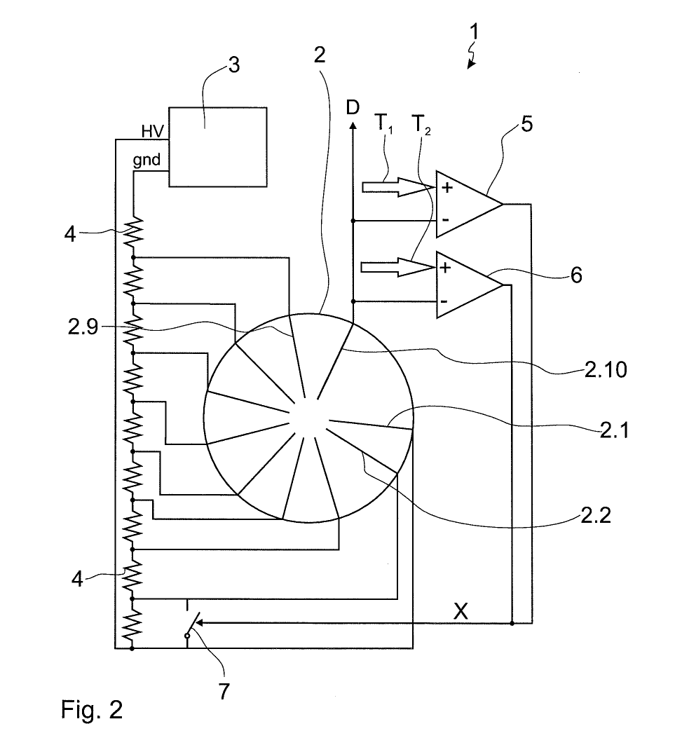

FIG. 2 shows the circuit diagram of an example of an embodiment of an operating circuit 1 according to the invention for a PMT 2. For a better understanding, only relevant components are represented. The PMT comprises, besides an evacuated housing (not shown), a photocathode 2.1, eight dynodes 2.2-2.9, and an anode 2.10. The operating circuit 1 comprises a high voltage source 3 whose voltage is applied through a series of resistors 4, so that, at each resistor 4 and the dynodes 2.2-2.9 adjacent to it, a respective partial voltage decreases. The resulting potential cascade multiplies in a known way the photoelectrons deflected at the photocathode 2.1. The current pulse which occurs as a result at the anode 2.10 can be converted, for example, by means of a current voltage converter (not shown), into an electrical voltage as anode signal D.

At the anode 2.10, a first comparator 5 and a second comparator 6 are connected, which compare the anode signal D with predetermined threshold signals T₁, T₂. The result signals are superposed, and, as switch signal X, delivered to a high-voltage insulated switch 7 of which one pole is connected to the photocathode 2.1 and the other pole to the first dynode 2.2. The switch 7 can be designed, for example, as an optocoupler, isolation amplifier or relay. It is advantageously designed as a NO contact, producing, in the closed switching status, a short circuit between the photocathode 2.1 and the first dynode 2.2. As long as its switch signal X presents at least a predetermined negative level, it closes. The value of the first threshold signal T₁ is greater than that of the second threshold value T₂, so that the result is a switch hysteresis.

The first comparator 5 evaluates the PMT anode signal D after the current voltage conversion, and in case of an overload, which can be identified if the first threshold value T₁ is exceeded by the anode signal D, the first comparator generates the switch signal X in such a way that the switch 7 is actuated. The latter with its work contact short circuits the cathode 2.1 with the first dynode 2.2, so that the first acceleration level of the PMT 2 is deactivated. An additional comparator 6 monitors the consequently substantially smaller anode signal D, which, however, proportionally corresponds to the original, that is the activated first acceleration step. If it now falls below the second threshold signal T₂, then the end of the overload is identified, and the switch signal X becomes sufficiently negative again so that the work contact of the switch 7 opens. The acceleration voltage between the cathode 2.1 and the first dynode 2.2 subsequently is regenerated in as short a time as possible. The first acceleration level is thus reactivated. During the entire process of the deactivation and reactivation of the PMT 2, the high voltage HV of the voltage source 3 is maintained.

Instead of two comparators 5, 6, it is advantageous to use a Schmitt trigger to actuate the switch 7 with hysteresis.

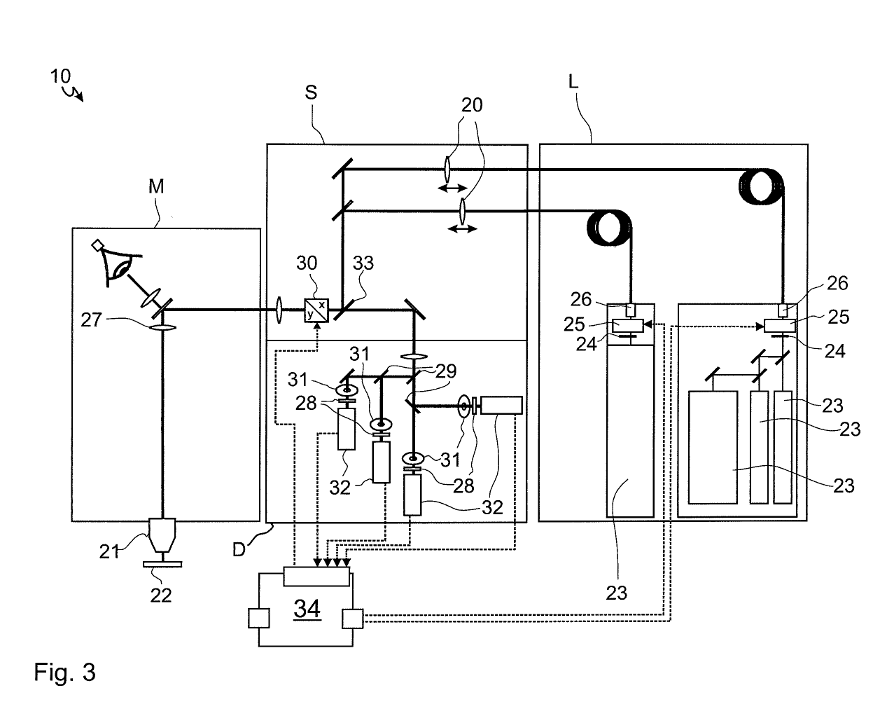

In FIG. 3, a laser scanning microscope 10 with PMT operated according to the invention is represented schematically. The LSM 10 is composed on a modular basis from an illumination module L with lasers 23, a scanning module S, a detection module D, and the microscope unit M with the microscope lens 31.

The light of the laser 23 can be influenced by the control unit 34 by means of light flaps 24 and attenuators 25, for example, an acousto-optic tunable filter (AOTF), before it is introduced through light guide fibers and coupling optics 20 into the scanner S and combined. Through the main beam splitter 33 and the X-Y scanner 30, which presents two galvanometer reflectors (not shown), it reaches, through the microscope lens 21, the sample 22, where it illuminates a focal volume (not shown).

Light reflected or fluorescence light emitted by the sample reaches, through the microscope lens 21, and then via the scanner S through the main beam splitter 30 and the detection module DET. The main beam splitter 30 can be designed, for example, as a dichroitic color splitter. The detection module DET presents several detection channels each with a pin diaphragm 31, a filter 28, and a PMT detector 2, which are separated by color splitters 29. Instead of pin diaphragms 31, slit diaphragms can be used, for example, in case of linear illumination. The confocal pin diaphragms 31 serve for the discrimination of sample light that does not originate from the focal volume. The detectors 2 therefore detect exclusively light from the focal volume. The detectors 2 comprise a respective operating circuit according to FIG. 2 as well as respective processing electronics. In other embodiments, the processing electronics can be removed from the detectors 2, in particular, they can be arranged outside of the detection module DET.

The confocally illuminated and recorded focal volume of the sample 22 can be moved over the sample 22, for example, by means of the scanner 30, to record an image pixel by pixel, by rotating the galvanometer mirror of the scanner 30 in a controlled way. Both the movement of the galvanometer reflector, and also the switching of the illumination by means of the light flaps 24 or of the attenuators 25 are controlled directly by the control unit 34. The data recording by the detectors 2 is also carried out via the control unit 34. The processing unit/control unit 34 can be, for example, a commercial electronic computer.

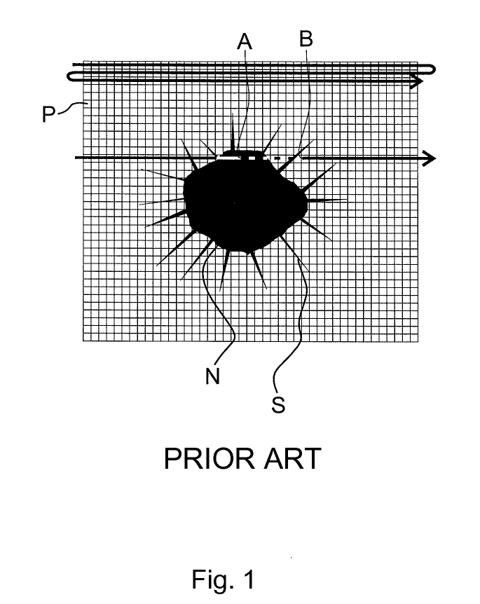

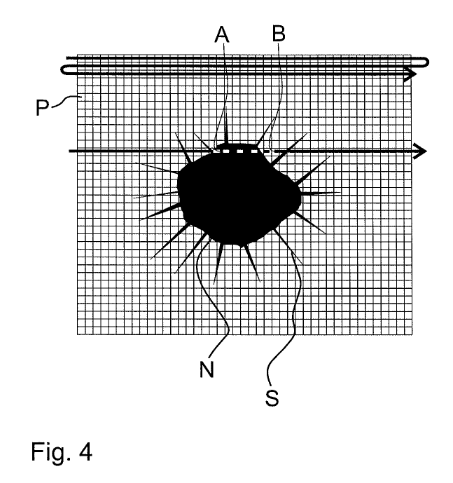

FIG. 4 shows the advantageous consequences of using the operating switch according to the invention in an LSM. In contrast to FIG. 1, the deactivation of the detection at time A occurs nearly immediately after the entry of the focus into the body of the neuron, which reduces the useful life of the PMT only insubstantially. The reactivation of the detection occurs at time B also nearly immediately after the exit of the focus from the body of the neuron N. As a result, the subsequent synapses S can be detected regularly. In a realistic recording, the user will have the full anode signal D available again just a few pixels after the end of an extremely bright area.

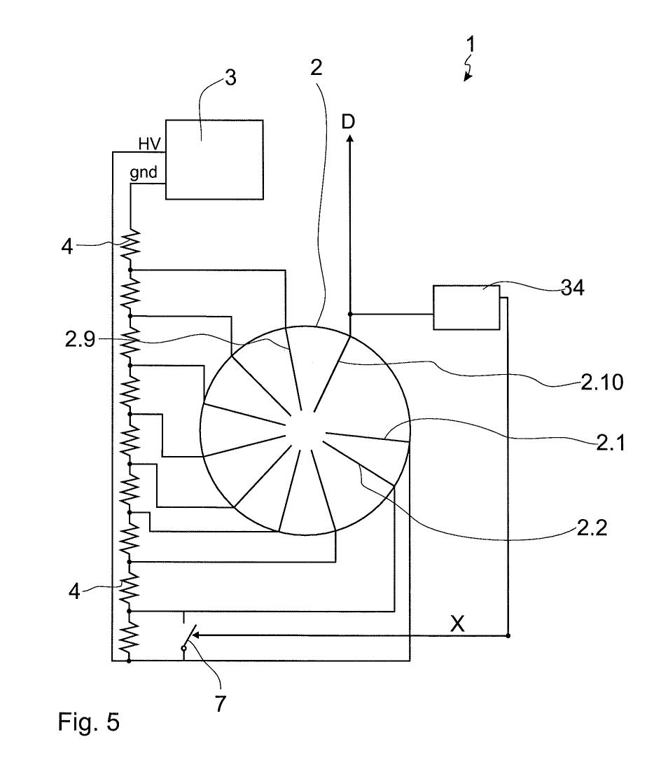

In FIG. 5, an operating circuit with a switch for reversing the polarity of the voltage between the first dynode 2.2 and the photocathode 2.1 is represented, which is activated by a control unit 34 if a first threshold value T₁ has been exceeded by the anode signal D, and deactivated again, for example, after a predetermined time period of 10 μs.

Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically disclosed.

### LIST OF REFERENCE NUMERALS

1 Operating circuit
2 PMT
2.1 Photocathode
2.2-2.9 Dynodes
2.10 Anode
3 High voltage source
4 Resistors
5 First comparator
6 Second comparator
7 Switch
10 Laser scanning microscope
20 Collimation optics
21 Microscope lens
22 Sample
23 Laser
24 Light flap
25 Attenuator
26 Fiber coupler
27 Tube lens
28 Filter
29 Dichroitic beam splitter
30 Scanner
31 Pin diaphragm
32 Photomultiplier
33 Main beam splitter
34 Control unit
35 Light source
A, B times
D Anode signal
T₁, T₂ Threshold signals
X Switch signal
HV High voltage
L Illumination module S Scanning module
Microscope unit
DET Detection module

1. An operating circuit for a photomultiplier which has a photocathode, a plurality of dynodes and an anode, the operating circuit comprising:
an electrical circuit to apply to the dynodes a respective voltage with respect to the photocathode; and
a switch, the switch being connected to the photodiode and the dynode that is closest to the photodiode for electrically short circuiting the photocathode with the closest dynode.

2. The operating circuit according to claim 1, further comprising:
a first comparator connected to the switch for comparing an anode signal from the anode with a predetermined first threshold value, wherein the anode signal closes the switch, if a value of the anode signal exceeds the first threshold value.

3. The operating circuit according to claim 2, further comprising a second comparator for comparing the anode signal with a predetermined second threshold value, where the second comparator is connected to the switch, and opens the switch, if a value of the anode signal falls below the second threshold value.

4. The operating circuit according to claim 3, where the two comparators are identical.

5. The operating circuit according to claim 3, where the two threshold values are identical.

6. A light scanning microscope comprising:
a photomultiplier having a photocathode, a plurality of dynodes and an anode,
an electrical circuit to apply to the dynodes a respective voltage with respect to the photocathode; and
a switch, the switch being connected to the photodiode and the dynode that is closest to the photodiode for the electrical short circuiting of the photocathode with the closest dynode.

7. The light scanning microscope according to claim 6, where the electrical switch comprises a switch with a maximum reaction time of 1 μs.

8. A control method for a photomultiplier having a photocathode, a plurality of dynodes and an anode, comprising the steps of stressing the dynodes by a respective voltage with respect to the photocathode, and short circuiting the photocathode with the dynode that is closest to the photocathode.

9. The control method according to claim 8, wherein the short circuiting occurs, if it is identified that a value of an anode signal from the anode exceeds a predetermined first threshold value, where the short circuit is interrupted, if it is identified that a value of the anode signal from the anode falls below a predetermined second threshold value.

10. The operating circuit according to claim 1, wherein the remaining dynodes, in the case of a short circuit of the first dynode with the photocathode, present an electrical potential with respect to the photocathode, which is not zero.

11. An operating circuit for a photomultiplier having a photocathode, a plurality of dynodes and an anode, the operating circuit comprising:
an electrical circuit for the application to the dynodes of a respective voltage with respect to the photocathode; and
an electrical circuit for reversing the polarity of a voltage between the dynode that is closest to the photocathode, and a photocathode and
a control unit which activates the polarity reversal, if the control unit identifies that a value of an anode signal from the anode exceeds a predetermined first threshold value, and deactivates the polarity reversal after a predetermined time period.
